(19) United States
(12) Patent Application Publication
(10) Pub. No.: US 2002/0064216 A1
(43) Pub. Date: May 30, 2002

(54) Spread spectrum receiver and related method

(75) Inventors: Andrew T. Yule, Felbridge East Grinstead (GB); Bryan D. Young, Surrey (GB); Timo Giesselmann, Hamburg (DE)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/040,171

(22) Filed: Oct. 23, 2001

(30) Foreign Application Priority Data
Oct. 25, 2000 (GB) 0026092.7

(51) Int. Cl. H04L 27/30; H04B 15/00; H04B 1/707; H04B 1/69; H04K 1/00; H04B 1/713

(52) U.S. Cl. 375/150

(57) ABSTRACT

The present invention provides for spread spectrum receiver (1) and related method arranged for the receipt and processing of a spread spectrum signal wherein a PRN code is generated locally as an intended replica of a received signal code and a correlation threshold test is conducted on the received signal to determine the state of suspected code acquisition. The baseband signal derived from the received signal is processed by the microprocessor (14) but the correlation threshold test is conducted remote from the microprocessor (14) and a received signal is then flagged for subsequent processing by the microprocessor (14) if the threshold value according to the correlation threshold test is exceeded.

### FIELD OF THE INVENTION

The present invention relates to a spread spectrum receiver having at least one channel and a PRN code generator for providing a replica code, a primary microprocessor associated with the channel for baseband processing during signal acquisition, and means for conducting correlation threshold tests on the received signal so as to determine suspected code acquisition.

The invention also relates to a method of receiving and processing a spread spectrum signal comprising the steps of generating a PRN code for providing a locally generated replica of the received signal code, conducting a correlation threshold test on the received signal to determine the state of suspected code acquisition and processing the baseband signal derived from the received signal by means of a microprocessor.

### BACKGROUND OF THE INVENTION

Spread spectrum communication systems find a wide variety of uses particularly where immunity to interference and security of communication are considered important factors. Common uses are in the Global Positioning System (GPS) satellite location system and also with digital cellular telephony where selective addressing and code division multiple access (CDMA) can be implemented.

The use of spread spectrum systems within GPS is well documented. The spread, or encoded, signal received by the GPS hardware is first received and then down-converted to an intermediate frequency (IF) signal which is then fed to the plurality of receiver channels commonly found within the GPS hardware. The receiver is arranged to generate a pseudo carrier wave with substantially the same frequency as the received signal and two versions of such a carrier signal are generated. A first of these two signals is in the form of sine wave and the other, being 90 degrees out of phase comprises a cosine wave. The incoming signal is duplicated and one version combined with the sine replica carrier and the other with the cosine replica carrier. As is commonly known, this results in two signals. An In-Phase signal (I) and a Quadrature-Phase signal (Q), which is 90 degrees out of phase with the in-phase signal (I).

It is common during signal acquisition to require the baseband hardware to conduct a two-dimensional energy search as part of a threshold test so as to determine whether the detected energy level is greater than a pre-determined threshold level. The energy level is commonly calculated as equating to

√(I²+Q²)

and the threshold test is carried out by the baseband hardware in the form of a microprocessor typically at a rate of 1,000 tests per second per channel of the GPS receiver. The two-dimensional energy search is achieved by sweeping the code phase of the code portion of the locally generated signal and also by providing different offset values of carrier frequency. As will be appreciated, this creates a substantial processing overhead with the vast majority of the tests conducted in accordance with the two dimensional energy search failing and requiring no further action by the microprocessor.

The use of the baseband microprocessor to conduct a large number of comparatively simple tests, most of which fail, is inefficient. Also, it is normal for the microprocessor to be interrupted in order to carry out each test. This represents a further unnecessary overhead on the microprocessor since, at each interrupt, the microprocessor has to save its current state before servicing the interrupt. Then, subsequent to handling the interrupt which, as stated above, is more than likely to present a failed test, the aforementioned current state of the microprocessor has to be restored.

Problems of this nature become all the more significant due to the increasing complexity of the applications and operating systems software on the controlling microprocessor and which result in an increase in the overheads associated with interrupt servicing. Further, the number of parallel channels employed by, for example, a GPS receiver, is generally increasing which serves to further increase the load on the processor.

### OBJECT OF THE INVENTION

The present invention seeks to provide for a spread spectrum receiver and related method, having operational advantages over such receivers and related methods and, in particular, such receivers and related methods in which the processing burden on the microprocessor is reduced.

### SUMMARY OF THE INVENTION

According to one aspect of the present invention there is provided a spread spectrum receiver as defined above wherein the means for conducting correlation threshold tests on the received signal comprises further processing means, and the receiver further includes means for flagging a received signal for processing by the primary microprocessor if a threshold value in accordance with the threshold test is exceeded.

The invention therefore advantageously provides for additional processing means that can be associated with each channel of the receiver and which is arranged for conducting, for example, the conventional correlation threshold tests during a sweep of the PRN code and wherein the received signal is flagged for primary processing means only when a useful correlation result is returned. The useful result therefore serves to identify a suspected code acquisition within the receiver. Since, as noted above, the majority of correlation threshold tests are found to be negative, the invention advantageously can substantially reduce the processing load on the primary microprocessor since the vast majority of received signals will not actually be flagged for subsequent processing by the microprocessor.

This proves to be particularly advantageous when compared with known arrangements in which each receiver channel and its associated Numerically Controlled Oscillator is controlled by way of the same microprocessor as is used for baseband processing during signal acquisition.

The reduction in the load on the baseband microprocessor leads to related advantages such as savings in power consumption and/or silicon area requirements.

According to another aspect of the present invention, there is provided a method of receiving and processing a spread spectrum signal as defined above wherein the correlation threshold test is conducted remote from the microprocessor and a received signal is flagged for processing by the microprocessor if the threshold value according to the correlation threshold test is exceeded.

The feature of claim 2 has the advantage of facilitating an at least part automated threshold test on the incoming signal which greatly simplifies the overall arrangement of the receiver.

The features of claims 3, 4, 5, 13 and 14 exhibit the advantage that a particularly efficient and accurate thresholding test arrangement can be provided.

The features of claims 6 and 15 have the advantage that the processing overhead on the microprocessor can be further reduced since the processor is not frequently interrupted to check for a flagged signal but, rather, is only allowed to service an interrupt if it is determined that a flagged signal is awaiting processing.

The feature of claim 7 has the advantage that it serves to implement accurate timing within the controlling software.

The feature of claim 8 and 16 has the advantage that it can further reduce the load on the microprocessor.

### BRIEF DESCRIPTION OF DRAWINGS

The invention is described further hereinafter, by way of example only, with reference to the accompanying drawings in which:

FIG. 1 is a schematic view of a digital GPS receiver according to the prior art;

FIG. 2 is a schematic view of the receiver channel 13 co-operating with the receiver processor 14 of the GPS receiver of FIG. 1 in greater detail;

FIG. 3 is a schematic view of a digital receiver channel 13 co-operating and a receiver processor 14 in a digital GPS receiver according to the present invention; and

FIGS. 4a and 4b comprise timing diagrams illustrating operation of an eight-channel receiver according to one particular aspect of the present invention.

### DESCRIPTION OF THE PREFERRED EMBODIMENTS

It should be noted that the same reference signs are generally used to refer to corresponding or similar features in different embodiments.

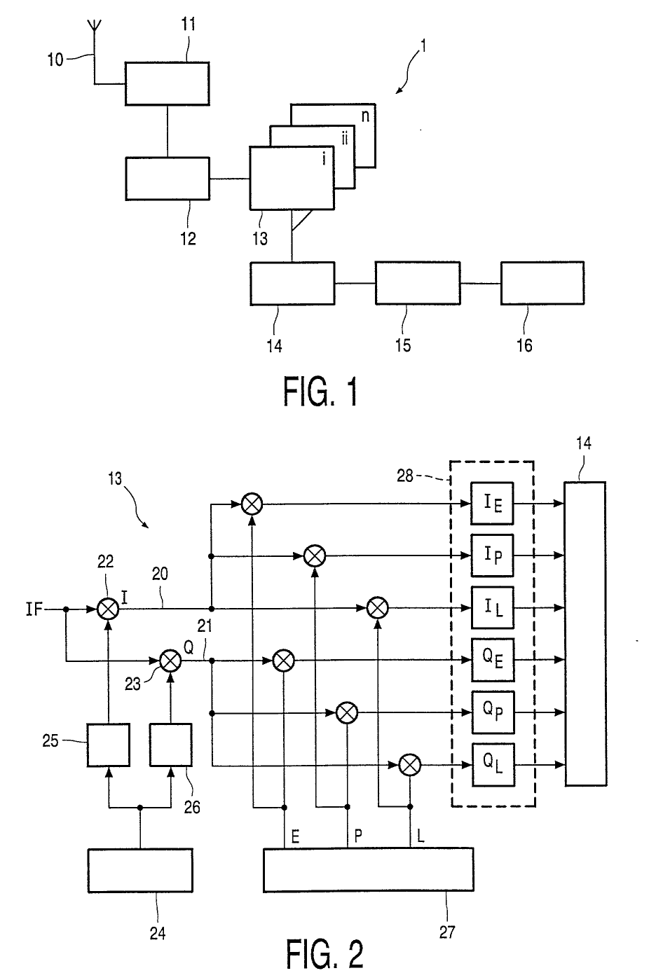

FIG. 1 shows, schematically, the architecture of a GPS receiver 1 according to the present invention. When operative, the GPS receiver 1 receives NAVSTAR GPS signals through an antenna 10 and pre-process them in a RF signal pre-processor 11, typically by passive bandpass filtering in order to minimize out-of-band RF interference, preamplification, down conversion to an intermediate frequency (IF) and analog to digital conversion. The resultant, digitised IF signal remains modulated, still containing all the information from the available satellites, and is fed into a first in-first out (FIFO) memory 12. From the memory, the samples may be fed at any time later into each of a series of parallel receiver channels 13. The satellite signals are acquired and tracked in respective digital receiver channels in co-operation with the receiver processor 14 for the purpose of acquiring pseudorange information. Such methods for acquisition and tracking are well known, for example, see chapter 4 (GPS satellite signal characteristics) & chapter 5 (GPS satellite signal acquisition and tracking), of GPS Principles and Applications (Editor, Kaplan) ISBN 0-89006-793-7 published by Artech House. Using acquired navigation information and the time of arrival of the transmissions, the navigation processor 15 calculates the position of the receiver using conventional algorithms and that position is displayed on a display 16 to the user.

The pre-processor 11 will be typically implemented in the form of front end analogue circuitry with the digital receiver channels 12, the receiver processor 13 and the navigation processor 14 implemented in the form of a general purpose microprocessor or a microprocessor embedded in a GPS application specific integrated circuit (ASIC).

FIG. 2 shows, schematically, the receiver channel 13 co-operating with the receiver processor 14 in greater detail wherein the digitised IF signals are applied to the input. For simplification, only the functions associated with the code and carrier tracking loops are illustrated and the receiver channel is assumed to be tracking the Space Vehicle (SV) signal in steady state mode. First the digital IF is stripped of the carrier (plus carrier Doppler) by the replica carrier (plus carrier Doppler) signals to produce the I 20 and Q 21 sampled data. It should be noted that the replica carrier signal is being mixed with all the GPS SV signals and noise at the digital IF. The I and Q signals at the outputs of the mixers 22, 23 have the desired phase relationships with respect to the detected carrier of the SV. However, the code stripping processes that reduces these signals to baseband have not yet been applied. Therefore, the I signal at the output of the in-phase mixer 22 comprises mostly thermal noise multiplied by the replica digital sine wave and the Q signal at the output of the quadra-phase mixer 23 is the product of mostly thermal noise and the replica digital cosine wave. The desired SV signal remains buried in noise until the I and Q signals are reduced to baseband by the code stripping process that follows. The replica carrier (including carrier Doppler) signals are synthesized by the carrier NCO 24 and the discrete sine and cosine mapping functions 25, 26.

By producing I and Q component phases 90 degrees apart, the resultant signal amplitude can be computed from the vector sum of the I and Q components and the phase angle with respect to the I-axis can be determined from the arctangent of Q/I. In closed loop operation, the carrier NCO 24 is controlled by a carrier tracking loop in the receiver processor 14. In phase lock loop (PLL) operation, the objective of the carrier tracking loop is to keep the phase error between the replica carrier and the incoming SV carrier signals at zero. Any misalignment in the replica carrier phase with respect to the incoming SV signal carrier phase produces a non zero phase angle of the prompt I and Q vector magnitude so that the amount and direction of the phase change can be detected and corrected by the carrier tracking loop. When the PLL is phase-locked, the I signals are maximum and the Q signals are nearly zero.

Not shown are the controls to the code generator 27 that permit the receiver processor to preset the initial code-tracking phase states, which are required during the code search and acquisition process.

A pre-detection stage occurs and comprises signal processing after the IF signal has been converted to baseband by the carrier and code stripping processes, but prior to being passed through a signal discriminator, i.e. prior to the non-linear signal detection process. Numerous digital pre-detection integration and dump operations occur after the carrier and code stripping processes. This causes very large numbers to accumulate even though the IF A/D conversion process is typically with only one to three bits of quantisation resolution.

The channel includes integrate and dump accumulators 28 which provide filtering and resampling at the processor baseband input rate, which is around 1 kHz. The hardware integrate and dump process in combination with the baseband signal processing integrate and dump process defines the pre-detection integration time. The pre-detection integration time is a compromise design. It must be as long as possible to operate under weak or RF interference signal conditions and it must be as short as possible to operate under high-dynamic stress signal conditions.

As will be appreciated, in this illustrated example which is typical of the prior art the receiver processor 14 is arranged to conduct a variety of processing/control functions including the threshold testing during signal acquisition and also the eventual baseband processing on the de-spread signal.

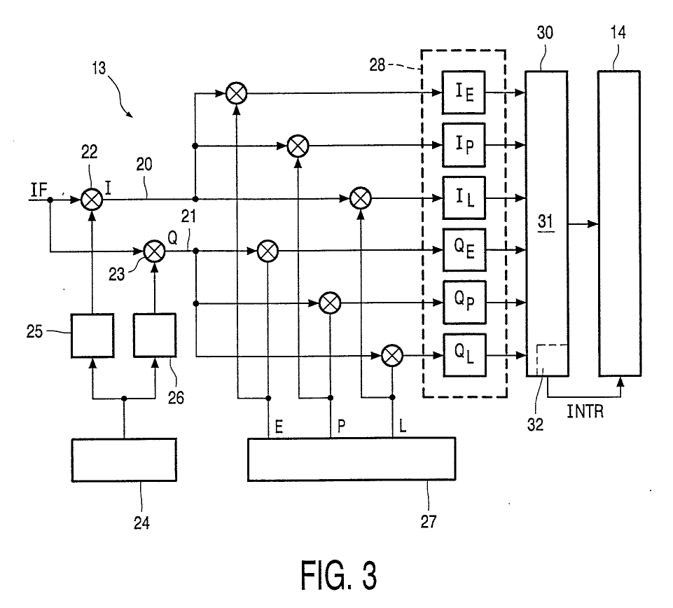

FIG. 3 is a schematic view of a digital receiver channel 13 and a receiver processor 14 of a digital GPS receiver embodying the present invention. In addition to convention elements of a GPS receiver as described above, further provided is an intermediate processor 30 incorporating threshold detection circuitry 31 used to conduct correlation threshold tests on the received signals and interrupt generation circuitry 32 used to either flag or interrupt the primary receiver processor 13 in the event that the result of a threshold test suggests signal acquisition. I.e. the code phase sweep is controlled by the intermediate processor.

Such flagging and/or interrupting of the primary receiver processor can be done any of the following ways:

In a “standard” mode of operation, the primary receiver processor is regularly interrupted to interrogate the intermediate processor to see if it is being flagged, i.e. to see if a threshold test indicative of signal acquisition has occurred. In the event that this is the case, the primary receiver processor may then verify the threshold test and/or attempt to track the signal for which acquisition if indicated.

A further “conditional interrupt” mode of operation may be provided where the primary receiver processor is only interrupted when the intermediate processor is flagging the primary receiver microprocessor. This prevents interrupt overhead if none of the channels needs servicing.

A yet further “interrupt latency” mode of operation may be provided where the primary receiver processor is only interrupted when the intermediate processor is flagging the primary receiver microprocessor and that flag is about to be overwritten with the results of a subsequent threshold test. This feature can be used to service multiple channels with the same interrupt service routine.

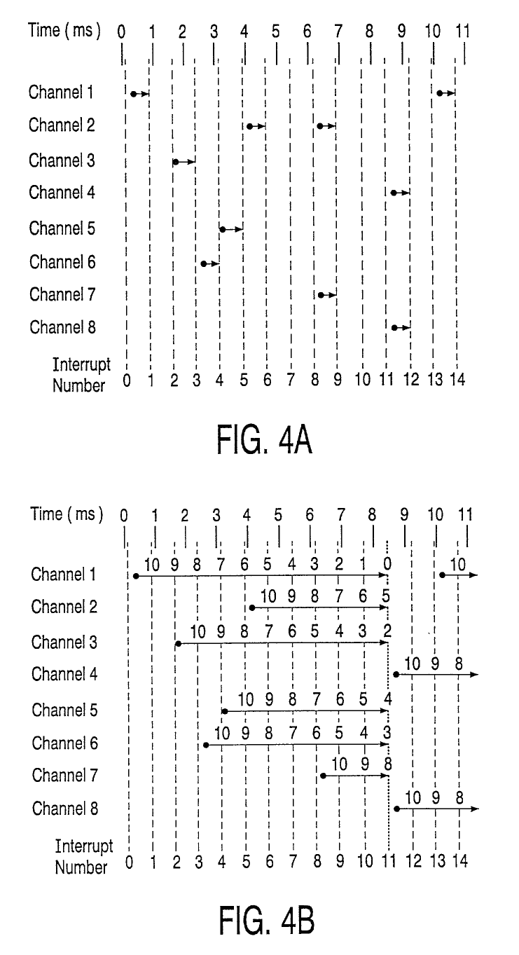

As will be appreciated from the foregoing description, the invention provides for additional processing means associated with each channel and the related flagging of information for subsequent processing by microprocessor in a manner in which serves to reduce the load on the microprocessor. Additional measures providing for further advantageous decreases in microprocessor load arise through only interrupting the microprocessor when a correlation indicative of PRN code acquisition is flagged and also only interrupting the microprocessor at a predetermined time before a flag is to be overwritten and at which time other flagged correlation channels can be serviced. This further aspect is now described further in relation to FIGS. 4a and 4b.

Each time the microprocessor is required to service an interrupt it must first save its current state before servicing the interrupt and then restore that state after servicing the interrupt. As will be appreciated and as discussed above, this results in an overhead of “wasted processor time” which increases in proportion to the number of interrupts that are raised.

The effect of the combination of long integration periods (e.g. 10 ms) and the above-mentioned additional processing means is to reduce the frequency with which channels need intervention by the microprocessor. The adoption of conditional interrupts as discussed above serves to address how time spent servicing interrupts where nothing is to be done can be avoided, however under typical circumstances the servicing of 8 or 12 channels may still be done on different interrupts, leading to the interrupt servicing overhead being incurred for each channel every integration period. For example, consider the case where 8 channels are each generating data every 10 ms (but with different offsets). If the interrupt period is a typical value of 0.8 ms (which is necessary to handle a few occasions when a rapid response is essential), then 12 or 13 interrupts will be generated in the period between a given channel generating one set of data to the next. FIG. 4a illustrates such a situation.

A scale of elapsed time (in ms) is marked along the top of FIG. 4a, with the regular interrupts shown as vertical lines (dashed or dotted), numbered along the bottom. Each channel independently generates data at 10 ms intervals (indicated by the black circle) and the processor responds to that by servicing the channel on the next interrupt (indicated by the black arrow just after the circle). The interrupts for which there is one or more channel to service are shown with dotted rather than dashed lines. Using conditional interrupts as discussed above, those numbered 0, 2, 7, 8, 10, 11 and 13 would not be generated. However, in this example, just over half the potential interrupts would still have to be generated with their associated processor overhead.

FIG. 4b serves to further illustrate the advantages that can be achieved by introducing predetermined latency into each channel of the receiver.

In one example of the further feature a programmable latency is added to each channel to indicate the period for which new data generated by the channel can be held onto before the processor must read it. This latency period can be defined in terms of an integer number of interrupt intervals and can be used to prime a counter in the channel each time new data is generated.

Thereafter the counter on each channel is decremented at each potential interrupt and an interrupt will only be generated when one of the counters reaches zero.

FIG. 4b illustrates how this might effect the example shown in FIG. 4a. In this case each channel has been given a latency of 11 and the FIG. 4b shows how the value decrements at each subsequent interrupt point. In this example, the only interrupt to be raised to the processor is number 11 (when the counter on channel 1 reaches 0), at which point six of the eight channels have data to be serviced.

This advantageously further limits the demands on the microprocessor.

The addition of these latency counters has little effect on the complexity of the custom hardware, but should clearly lead to a saving in processor load.

Although the present invention has been described in particular in relation to the GPS system, it should be appreciated that the overall concept can be applied to other satellite navigation systems and also to spread spectrum receivers in general.

All possible embodiments of the present invention nevertheless exhibit the primary advantage that the further processing means provided within the receiver channel will effectively request intervention by the processor far less often than within conventional systems and so allowing for a considerable saving in processor load. Also, the time taken for the processor to respond to a channel requesting intervention when it is required will become much less time-critical.

Implementation of an intermediate processor having threshold detection and interrupt/flagging functionality, including the specific functionality described above, would be accomplished by appropriate digital circuitry design and/or microprocessor programming. Of course, such design and programming is well known and would be accomplished by one of ordinary skill in that art without undue burden.

From a reading of the present disclosure, other modifications will be apparent to the skilled person skilled and may involve other features which are already known in the design, manufacture and use of GPS and other spread spectrum signal receivers and component parts thereof and which may be used instead of or in addition to features already described herein. Although claims have been formulated in this application to particular combinations of features, it should be understood that the scope of the disclosure of the present application also includes any novel feature or any novel combination of features disclosed herein either explicitly or implicitly, whether or not it relates to the same invention as presently claimed in any claim and whether or not it mitigates any or all of the same problems as does the present invention. The applicants hereby give notice that new claims may be formulated to such features and/or combinations of such features during the prosecution of the present application or of any further application derived therefrom.

1. A spread spectrum receiver having at least one channel, a PRN code generator for providing a replica code, a primary microprocessor associated with the channel for baseband processing during signal acquisition and means for conducting correlation threshold tests on the received signal so as to determine suspected code acquisition, wherein the means for conducting correlation threshold tests on the received signal comprises further processing means, and the receiver further includes means for flagging a received signal for processing by the primary microprocessor if a threshold value in accordance with the threshold test is exceeded.

2. A receiver as claimed in claim 1 wherein the further processing means comprises secondary hardware in the form of a dedicated circuit.

3. A receiver as claimed in claim 1 wherein a code sweep of the threshold test is arranged to be selectively conducted at one of two different speeds.

4. A receiver as claimed in claim 3 wherein the code sweep is initially conducted at a first speed but switches to a second, and slower, speed upon suspected code phase acquisition.

5. A receiver as claimed in claim 4 wherein the slower sweep is arranged to provide confirmation of the code acquisition prior to flagging the signal for processing by the primary microprocessor.

6. A receiver as claimed in claim 1 wherein the microprocessor receives an interrupt signal serving to initiate a check for a flagged signal and wherein the generation of the interrupt signal is responsive to the existence of a flagged signal.

7. A receiver as claimed in claim 6, including counting means arranged to increment at the time of generation of each possible interrupt signal and irrespective of whether a flagged signal is available.

8. A receiver as claimed in claim 1, and arranged to delay the servicing of an interrupt for a delay period equal to the period of a plurality of potential interrupts from other channels and including means for determining the expiry of the said delay period and to control the servicing of the delayed interrupt and also any interrupts that have arisen on other channels during the said delay period.

9. A receiver as claimed in claim 8, wherein the said means for determining the expiry of the said delay period comprises decremental counting means.

10. A receiver as claimed in claim 8, wherein the said delay introduces a latency into each channel which is programmable.

11. A receiver as claimed in claim 1, wherein the further processing means is arranged to conduct a magnitude threshold function test comprising a two-dimensional energy search so as to determine whether an approximation of the energy level
√(I²+Q²)
in the form of max(I, Q)+min(I, Q)/2 is greater than the threshold value.

12. A method of receiving and processing a Spread Spectrum Signal comprising the steps of generating a PRN code for providing a locally generated replica of the received signal code, conducting a correlation threshold test on the received signal to determine the state of suspected code acquisition and processing the baseband signal derived from the received signal by means of a microprocessor, wherein the correlation threshold test is conducted remote from the microprocessor and a received signal is flagged for processing by the microprocessor if the threshold value according to the correlation threshold test is exceeded.

13. A method as defined in claim 12 wherein the correlation threshold test includes a code sweep which is conducted selectively at one of two different speeds.

14. A method as defined in claim 13 wherein the code sweep is initially conducted at a first speed but switches to a second, and slower, speed upon suspected code phase acquisition.

15. A method as defined in claim 12, including the step of initiating an interrupt signal for the microprocessor serving to initiate a check for a flagged signal, the initiation of the interrupt signal being responsive to the existence of a flagged signal.

16. A method as defined in claims 12, and including delaying the servicing of an interrupt for a delay period equal to the period of plurality of potential interrupts from other channels and servicing any interrupts that have arisen on the said other channels at the time of servicing the interrupt delayed by the said delay period.
